(19) United States
(12) Patent Application Publication
(10) Pub. No.: US 2013/0187562 A1
(43) Pub. Date: Jul. 25, 2013

(54) DEVICE AND METHOD FOR AUTOMATICALLY DETECTING INSTALLED LAMP TYPE

(71) Applicants: William Lawrence Keith, Lake in the Hills, IL (US); George Gruev, Lake Zurich, IL (US)

(72) Inventors: William Lawrence Keith, Lake in the Hills, IL (US); George Gruev, Lake Zurich, IL (US)

(73) Assignee: KONINKLIJKE PHILIPS ELECTRONICS N.V., Eindhoven (NL)

(21) Appl. No.: 13/825,330

(22) PCT Filed: Sep. 9, 2011
(86) PCT No.: PCT/IB2011/053949

§ 371 Date: Mar. 21, 2013

Related U.S. Application Data
(60) Provisional application No. 61/387,071, filed on Sep. 28, 2010.

(51) Int. Cl. H05B 41/36

(52) U.S. Cl. CPC H05B 41/36
USPC 315/224

(57) ABSTRACT

An apparatus (1100, 2000, 3000) executes an algorithm (2000) to determine a type of lamp (10) that is installed in a lighting unit (1000). The apparatus supplies power to the installed lamp (10) according to a first power control setting that will not overdrive the installed lamp when the installed lamp is of a first lamp type, and that will overdrive the installed lamp when the installed lamp is of a second lamp type. The apparatus (1100, 2000, 3000) detects whether the installed lamp (10) is overdriven at the first power control setting, and uses the detection result to determine the lamp type of the installed lamp (10). The apparatus (1100, 2000, 3000) then supplies power to the installed lamp (10) according to the determined lamp type.

### TECHNICAL FIELD

The present invention is directed generally to a lighting unit and a device for supplying power to a lamp in a lighting unit. More particularly, various inventive methods and apparatus disclosed herein relate to an arrangement and method for detecting a type of lamp that is installed into a lighting unit and for supplying power to the installed lamp according to its type.

### BACKGROUND

Certain types of lamps have the same physical configuration as each other and can be installed in the same lighting unit.

However, in some cases these different lamp types can have different power supply requirements. In such cases it is important to be able to identify the type of lamp that is installed in the lighting unit so that it can be driven properly.

For example, a T8 lamp is a standard fluorescent lamp having a tubular shape with a diameter of a one inch, a medium bi-pin base, and having several specified lengths, including 2 feet, 3 feet, and 4 feet. As is well known, a ballast is employed to supply power to drive a T8 fluorescent lamp. Among 4 foot T8 lamps, there are several different lamp types, including a first type of lamp which is a standard 32 watt T8 lamp, a second type of lamp which is an energy saving 28 watt T8 lamp, and a third type of lamp which is an energy saving 25 watt T8 lamp. All of these types of lamps can be installed in the same lighting fixture that supports a 4 foot T8 lamp, but each of these types of lamps has its own specific power supply requirements.

When a fluorescent lamp such as a T8 lamp is installed in a non-dimming system, the ballast provides a constant current to the lamp. In that case, a 25 watt T8 lamp has a lower operating voltage than a 28 watt T8 lamp (or a 32 watt T8 lamp) and therefore consumes less power.

However, when it is desired to provide a dimming capability for a fluorescent lamp such as a T8 lamp that is installed in a lighting arrangement that employs dimming, a ballast needs to be employed that supports a dimming operation. In general, existing dimming ballasts employ a feedback loop to operate the lamp at a desired setting for the desired level of dimming. Typically, dimming ballasts have either constant current or constant power control loops to achieve a deep dimming level. If an energy saving lamp is installed on a dimming ballast with a constant power control loop that is designed for a higher power lamp, especially at higher light output levels where little or no dimming is desired, the ballast will try to overdrive the lamp in order to satisfy its control loop requirements and therefore the energy saving lamp will not save energy, or will not save as much energy as would be expected and desired. In that case, when replacing a higher power lamp (e.g., 32 watt T8 lamp) with a lower power lamp (e.g., 28 watt T8 lamp), for example, it may be necessary to install a different ballast to match the lower power lamp.

It would be desirable to be able to substitute any one type of these lamps for any other type of these lamps in a particular lighting unit without also having to exchange the ballast that drives the lamp. In that case, it is desirable to have a lighting unit that can automatically detect the type of lamp that is installed therein, and to adjust operating parameters of the ballast accordingly, to properly drive the installed lamp.

Lamp determination in the past has typically used measurements such as filament resistance, lamp current, and lamp voltage to determine lamp type. This is an effective strategy when lamp characteristics are very different, but can have difficulties when these parameters don't have a large enough difference. For instance, a standard T8 32W lamp has the same filament resistance as 28W T8 and 25W T8 energy saving lamps. Lamp current is also the same for these lamps. The only difference between them is the lamp voltage, and this voltage can overlap with temperature changes and is difficult to measure.

Thus, there is a need in the art to provide an automated method of determining a type of lamp that is installed in a lighting unit. There is also a need to provide a device capable of driving a plurality of types of lamps, and also capable of automatically detecting the type of lamp which it is currently driving.

### SUMMARY

The present disclosure is directed to a system and method for detecting a type of lamp that is installed in a lighting unit. For example, the present disclosure describes a dimming ballast and associated controller for a fluorescent lamp that can automatically detect the type of fluorescent lamp that is installed in a lighting unit associated with the ballast, where each different fluorescent lamp type is associated with a corresponding power level at which the lamp is intended to be driven.

Generally, in one aspect, a device is provided for supplying power to an installed fluorescent lamp. The device comprises: a first circuit for receiving an input voltage and in response thereto supplying power to the installed fluorescent lamp, the first circuit including: a half bridge having first and second switches that are selectively turned on and off periodically, wherein each switch has a time T_{ON} in each period where the switch is turned on, and wherein the power level supplied to the installed fluorescent lamp varies with T_{ON}, and a resonant circuit for supplying the power from the half bridge to the installed fluorescent lamp; a feedback signal generator for supplying a feedback signal indicating an average current passing through the half bridge; a controller for receiving the feedback signal and in response thereto adjusting T_{ON}; and a memory device for storing a starting lamp type. The controller executes a start-up procedure for the installed fluorescent lamp, comprising: retrieving from the memory device data indicating the starting lamp type; supplying first and second control signals according to the starting lamp type to the first and second switches to cause the first circuit to warm-up the installed fluorescent lamp during a warm-up period; after the warm-up period, during a test interval supplying the first and second control signals to the first and second switches to cause the first circuit to supply power to the installed fluorescent lamp to attempt to overdrive the installed fluorescent lamp; monitoring T_{ON} during the test interval; determining the lamp type of the installed fluorescent lamp based on the monitored T_{ON}; and saving in the memory device data indicating the determined lamp type of the installed fluorescent lamp as the starting lamp type.

In one embodiment, the installed fluorescent lamp has one of a first lamp type corresponding to a first, higher, power level, and a second lamp type corresponding to a second, lower, power level, and the controller is further configured to: set a maximum value T_{ON-MAX} for T_{ON} according to the second lamp type; and compare the monitored T_{ON} to T_{ON-MAX}.

According to one optional feature of this embodiment, the controller is further configured to determine whether the installed fluorescent lamp belongs to the first lamp type or belongs to the second lamp type depending on whether the monitored T_{ON} equals T_{ON-MAX} during the test interval.

Generally, in another aspect, an apparatus comprises: a device configured to receive an input voltage and in response thereto to supply power to an installed lamp; and a controller. The controller is configured to execute an algorithm comprising: controlling the device to supply the power to the installed lamp according to a first power control setting that will not overdrive the installed lamp when the installed lamp is of a first lamp type and that will overdrive the installed lamp when the installed lamp is of a second lamp type, detecting whether the installed lamp is overdriven at the first power control setting; determining the lamp type of the installed lamp based at least in part on whether the installed lamp is overdriven at the first power control setting; and controlling the device to supply the power to the installed lamp according to the determined lamp type.

In one embodiment, the apparatus also includes a feedback signal generator that is configured to provide a feedback signal to the controller, and wherein the controller is configured: (1) to compare the feedback signal to a target value for driving the installed lamp, and (2) to determine whether the installed lamp is overdriven based on a result of the comparison.

According to one optional feature of this embodiment, the controller includes a comparator or amplifier that compares the feedback signal value to the target value, and wherein the controller determines that T_{ON} equals T_{ON-MAX} when an output of the comparator or amplifier is at one of its maximum and minimum values.

In one embodiment, the algorithm also comprises when it is determined that the lamp is overdriven at the first power control setting: controlling the device to supply the power to the installed lamp according to a second power control setting that will not overdrive the installed lamp when the installed lamp is of the second lamp type, and that will overdrive the installed lamp when the installed lamp is of the third lamp type, detecting whether the installed lamp is overdriven at the second power control setting; and determining the lamp type of the installed lamp based at least in part on whether the installed lamp is overdriven at the second power control setting.

Generally, in still another aspect a method is provided for supplying power to an installed lamp. The method comprises: supplying power to an installed lamp according to a first power control setting that will not overdrive the installed lamp when the installed lamp is of a first lamp type, and that will overdrive the installed lamp when the installed lamp is of a second lamp type; detecting whether the lamp is overdriven at the first power control setting; determining the lamp type of the installed lamp based at least in part on whether the installed lamp is overdriven at the first power control setting; and supplying the power to the installed lamp according to the determined lamp type.

In one embodiment, the method also includes: comparing a feedback signal to a target value for driving the installed lamp, and determining whether the installed lamp is overdriven based on a result of the comparison.

In one embodiment, the method also includes: selectively turning on and off first and second switches of a half bridge periodically, wherein each switch has a time T_{ON} in each period where the switch is turned on, and wherein a power level supplied to the installed lamp varies with T_{ON}.

According to one optional feature of this embodiment, the first lamp type corresponds to a first, lower, power level, and the second lamp type corresponds to a second, higher, power level, and the method comprises, during a test interval: setting a maximum value T_{ON-MAX} for T_{ON} corresponding to the first lamp type, monitoring TON, and comparing the monitored T_{ON} to T_{ON-MAX}.

According to one optional feature of this embodiment, the method further comprises determining whether the installed lamp belongs to the first lamp type or belongs to the second lamp type depending on whether the monitored T_{ON} equals T_{ON-MAX} during the test interval.

In one embodiment, the method also includes: supplying the power to the installed lamp according to a second power control setting that will not overdrive the installed lamp when the installed lamp is of the second lamp type, and that will overdrive the installed lamp when the installed lamp is of a third lamp type; detecting whether the lamp is overdriven at the second power control setting; and determining the lamp type of the installed lamp based at least in part on whether the installed lamp is overdriven at the second power control setting.

In one embodiment, the first lamp type corresponds to a first, higher, power level lamp, and the second lamp type corresponds to a second, lower, power level lamp.

In one embodiment, the method further comprises saving in a memory device data indicating the determined lamp type of the installed fluorescent lamp.

As used herein for purposes of the present disclosure, the term “lamp” should be understood to refer to any one or more of a variety of light sources, including, but not limited to, fluorescent sources, phosphorescent sources, high-intensity discharge sources (e.g., sodium vapor, mercury vapor, and metal halide lamps), incandescent sources (e.g., filament lamps, halogen lamps), lasers, LED-based sources, other types of electroluminescent sources, pyro-luminescent sources (e.g., flames), candle-luminescent sources (e.g., gas mantles, carbon arc radiation sources), photo-luminescent sources (e.g., gaseous discharge sources), cathode luminescent sources using electronic satiation, galvano-luminescent sources, crystallo-luminescent sources, kine-luminescent sources, thermo-luminescent sources, tribo luminescent sources, sonoluminescent sources, radio luminescent sources, and luminescent polymers.

A given light source may be configured to generate electromagnetic radiation within the visible spectrum, outside the visible spectrum, or a combination of both. Hence, the terms “light” and “radiation” are used interchangeably herein. Additionally, a light source may include as an integral component one or more filters (e.g., color filters), lenses, or other optical components. Also, it should be understood that light sources may be configured for a variety of applications, including, but not limited to, indication, display, and/or illumination. An “illumination source” is a light source that is particularly configured to generate radiation having a sufficient intensity to effectively illuminate an interior or exterior space. In this context, “sufficient intensity” refers to sufficient radiant power in the visible spectrum generated in the space or environment (the unit “lumens” often is employed to represent the total light output from a light source in all directions, in terms of radiant power or “luminous flux”) to provide ambient illumination (i.e., light that may be perceived indirectly and that may be, for example, reflected off of one or more of a variety of intervening surfaces before being perceived in whole or in part).

The term “lighting unit” is used herein to refer to an apparatus including one or more light sources of same or different types. A given lighting unit may have any one of a variety of mounting arrangements for the light source(s), enclosure/housing/fixture arrangements and shapes, and/or electrical and mechanical connection configurations. Additionally, a given lighting unit optionally may be associated with (e.g., include, be coupled to and/or packaged together with) various other components (e.g., control circuitry) relating to the operation of the light source(s).

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 shows a functional block diagram of one embodiment of a lighting unit.

FIG. 2 shows a flowchart of one embodiment of a method of determining a type of lamp that is installed in a lighting unit.

FIG. 3 shows a functional block diagram of relevant portions of one embodiment of a lighting unit.

FIG. 4 shows some details of relevant portions of one embodiment of a lighting unit.

FIG. 5 illustrates the timing of one embodiment of a procedure for a lighting unit to determine a lamp type of an installed lamp.

FIGS. 6A-B illustrate example operations of one embodiment of a lamp type determination procedure.

FIGS. 7-10 illustrate experimental results of execution of one embodiment of a lamp type determination algorithm under four different sets of conditions.

### DETAILED DESCRIPTION

More generally, Applicants have recognized and appreciated that it would be beneficial to provide a device and method that can automatically determine the type of lamp that is currently installed in a lighting unit and select appropriate parameters for supplying power to the determined lamp type.

In view of the foregoing, various embodiments and implementations of the present invention are directed to a lighting unit, a device for supplying power to a lamp installed in a lighting unit, a ballast for a lamp installed in a lighting unit, and a method of supplying power to a lamp installed in a lighting unit, which can determine the type of lamp that is installed in the lighting unit.

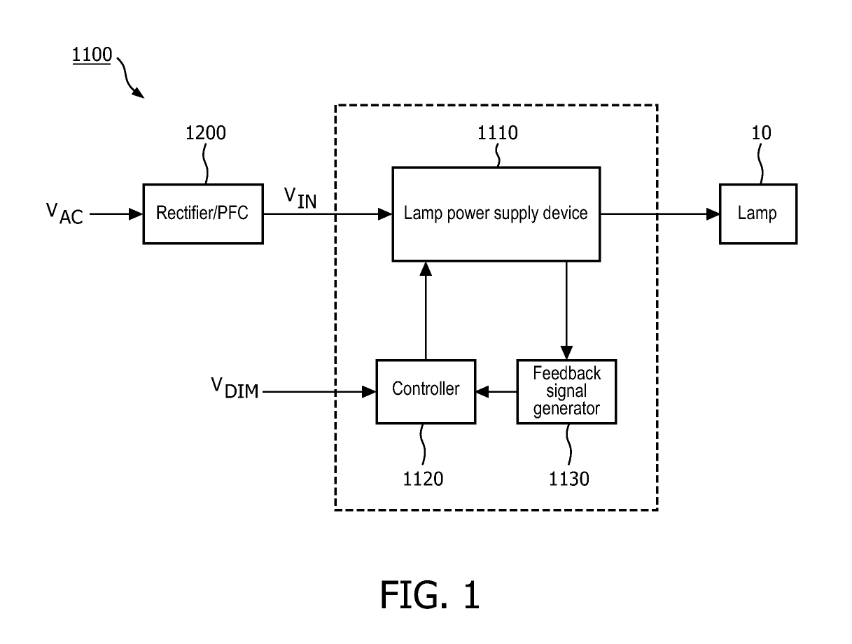

FIG. 1 shows a functional block diagram of one embodiment of a lighting unit 1000. Lighting unit 1000 includes an installed lamp 10, which may be installed in a lighting fixture (not shown) of lighting unit 1000, and an apparatus 1100 for supplying power to installed lamp 10. Lighting unit 1000 also includes a rectifier block 1200, which may further include a power factor correction (PFC) circuit, a dimming block, and other blocks that operate to convert a standard AC voltage from the electrical grid to a regulated DC voltage V_{IN} that is supplied to apparatus 1100 of lighting unit 1000. Apparatus 1100 includes a lamp power supply device 1110, a controller 1120, and a feedback signal generator 1130, and may be referred to as an electronic ballast. In the embodiment of FIG. 1, controller 1120 receives dimming voltage V_{DIM} which sets the amount of dimming to be applied to lamp 10 by apparatus 1100. Feedback signal generator 1130 and controller 1120 operate with lamp power supply device 1110 to form a power control loop for supplying an appropriate power to lamp 10 according to a desired dimming setting indicated by dimming voltage V_{DIM}.

Lighting unit 1000 is capable of employing at least two different types of lamps as the installed lamp 10, and apparatus 1100 is configured automatically to recognize, detect, or determine the type of lamp that is currently installed in lighting unit as installed lamp 10.

In one embodiment, lighting unit 1000 is configured to employ as installed lamp 10 a fluorescent lamp, for example a 4 foot T8 fluorescent lamp. In that case, installed lamp 10 may be a 32 watt T8 lamp (a first lamp type), or a 28 watt T8 lamp (a second lamp type), or a 25 watt T8 lamp (a third lamp type).

In that case, apparatus 1100 includes a feature wherein it is able automatically to detect whether installed lamp 10 is a 32 watt T8 lamp, a 28 watt T8 lamp, or a 25 watt T8 lamp so that it can supply the desired power level to lamp 10.

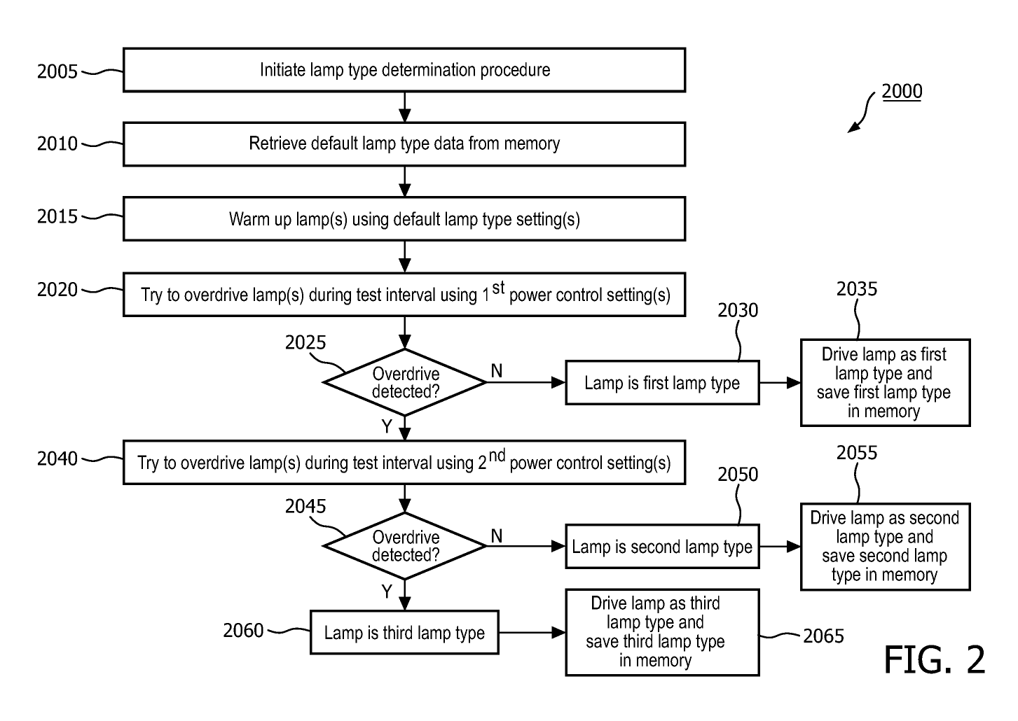

FIG. 2 shows a flowchart of one embodiment of a method 2000 of determining a type of lamp that is installed in a lighting unit which may be employed by apparatus 1100.

In a first step 2005, a lamp type determination procedure is initiated by an apparatus.

In some embodiments, a lamp type determination procedure may be initiated each time that a lighting unit is powered on. In some embodiments, a lamp type determination procedure may be initiated whenever an apparatus determines that a lamp has been replaced. In that case, for example, the apparatus may detect when it is driving an open load because a lamp has been removed, and then detect when the load is present again because a new lamp has been installed, and the apparatus may initiate the lamp type determination procedure upon detecting that the load is again present. Other criteria may be employed for initiating a lamp type determination procedure.

In a step 2010, an apparatus retrieves from a memory device stored lamp type data indicating a starting lamp type. The starting lamp type is a lamp type that is used as a starting point for the lamp determination procedure. In some embodiments, the stored lamp type data may correspond to a default lamp type stored into the memory device at the factory when the apparatus is manufactured. In some embodiments, the stored lamp type data may correspond to a lamp type that was detected by the apparatus the last time the apparatus was powered on. In some embodiments, the stored lamp type data may correspond to a lamp type that was last detected by the apparatus prior to detecting that a new lamp has been installed. The lamp type data may be any kind of data, including for example an ID code that may be used by an apparatus to identify the type of lamp that should be used by the lamp determination procedure as the starting lamp type.

In a step 2015, the installed lamp(s) is/are warmed up using power control settings for the starting lamp type.

In a step 2020, the apparatus tries to overdrive the installed lamp(s) during a test interval using first power control setting(s). Example embodiments of trying to overdrive an installed lamp will be described in greater detail below.

In a step 2025, the apparatus determines whether or not the installed lamp(s) is/are overdriven. Example embodiments of determining whether or not installed lamp(s) is/are overdriven will be described in greater detail below. If it is determined in step 2025 that installed lamp(s) is/are not overdriven, then in a step 2030 it is determined that the installed lamp(s) is/are of a first, higher power lamp type, for example a 32 W T8 lamp type. Then in a step 2035 the apparatus drives the lamp according to the first lamp type. Beneficially, data indicating the first lamp type is also stored in the memory device as the starting lamp type, and the procedure ends.

If it is determined in step 2025 that the installed lamp(s) is/are overdriven, then in a step 2040 the apparatus tries to overdrive the installed lamp(s) during a test interval using second power control setting(s).

In a step 2045, the apparatus determines whether or not the installed lamp(s) is/are overdriven. If it is determined in step 2045 that installed lamp(s) is/are not overdriven, then in a step 2050 it is determined that the installed lamp(s) is/are of a second, lower power lamp type, for example a 28 W T8 lamp type. Then in a step 2055 the apparatus drives the lamp according to the second lamp type. Beneficially, data indicating the second lamp type is stored in the memory device as the starting lamp type, and the procedure ends.

If it is determined in step 2045 that the installed lamp(s) is/are overdriven, then in a step 2060 it is determined that the lamp(s) is/are of a third, even lower power lamp type, for example a 25 W T8 lamp type. In a step 2065 the apparatus drives the lamp according to the third lamp type. Beneficially, data indicating the third lamp type is stored in the memory device as the starting lamp type, and the procedure ends.

In some embodiments where only two lamp types are contemplated, then steps 2040, 2045, 2060 and 2065 may be omitted, and when the installed lamp(s) is/are not overdriven in step 2025, it is determined that the installed lamp(s) is/are of a second, lower power lamp type, for example a 28 W T8 lamp type. Alternatively, in some embodiments where more than three lamp types are contemplated, steps similar to 2020-2035 or 2040-2055 may be repeated for each additional lamp type.

In method 2000, the apparatus begins testing for overdrive at the highest power level and if overdrive is detected, it then “works its way down” by testing at the next highest power level below that, and then the next power level below that, etc. until if finds a level that does not overdrive the lamp(s). However, in alternative embodiments, the apparatus may begin by testing at the lowest power level and if overdrive is detected, it then “works its way up” by testing at the next power level above that, and then the next power level above that, etc. until if finds a level that does overdrive the lamp(s). Other arrangements are also possible.

Although to provide a clear and concrete illustration, the example embodiment of FIG. 2 was described above in terms of fluorescent lamps, and in particular fluorescent T8 lamps, it should be understood that the illustrated method could be applied where appropriate to determining an installed lamp type for lamps employing other technologies.

In various embodiments, one or more of the following features may be applied to the method of FIG. 2: the warm-up procedure may always be executed at a high output level (rather than using the level for the starting lamp type stored in memory); and when changing T_{ON} in order to overdrive, visibility may be decreased by using a slow change (sweep).

Also in some cases where a lamp is replaced while a deep dimming level is applied to the lighting unit, the method 2000 may become visible to a user because it involves applying a high power level to the lamp(s) to try to overdrive it/them. Accordingly, so that the overdriving test is not visible to a user, in some embodiments in step 2005 after replacement of a lamp is detected, the lamp determination procedure may only be initiated once the amount of dimming is set to be very low (i.e., the lamp(s) have maximum or near maximum light output level). This has the side effect that the lighting unit may be set at the wrong power setting after replacing the lamp(s) until the light level is set high enough for the lamp determination procedure to be initiated.

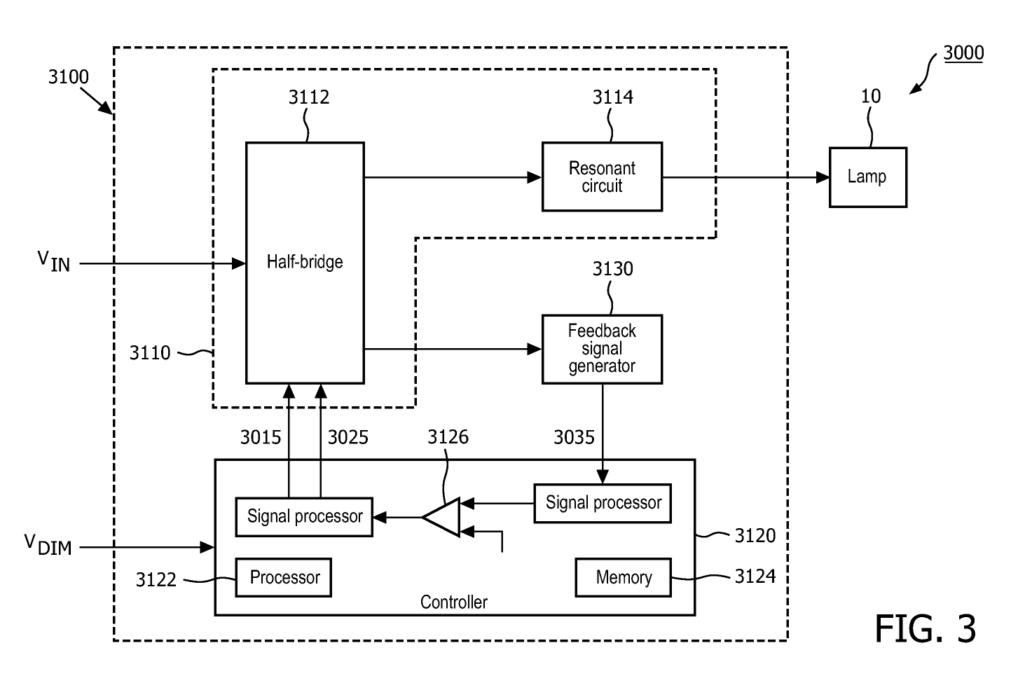

FIG. 3 shows a functional block diagram of relevant portions of one embodiment of a lighting unit 3000. Lighting unit 3000 includes an installed lamp 10, which may be installed in a lighting fixture (not shown) of lighting unit 3000, and an apparatus 3100 for supplying power to installed lamp 10. Apparatus 3100 includes a lamp power supply device 3110, a controller 3120, and a feedback signal generator 3130, and may be referred to as an electronic ballast. Power supply device 3110 includes a half-bridge 3112, a resonant circuit 3114, and a feedback signal generator 3130. Controller 3120 includes a processor (e.g., a microprocessor) 3122, a memory device 3124, comparator or amplifier 3126, and other signal processing components.

In operation, half bridge 3112 receives a voltage V_{IN}, which may be a regulated and power factor corrected DC voltage, and supplies power to installed lamp 10 via resonant circuit 3114. Controller 3120 receives a dimming control signal V_{IN} and regulates a power supplied by lamp power supply device 3110 to installed lamp 10 to achieve a corresponding level of dimming. In some embodiments, controller 3120 controls the power supplied from lamp power supply device 3110 to installed lamp 10 by adjusting a frequency of a signal output by half-bridge 3112 to resonant circuit 3114. In some embodiments, as the frequency of the signal output by half-bridge 3112 to resonant circuit 3114 is decreased, the power delivered by lamp power supply device 3110 to lamp 10 is increased.

In some embodiments, half bridge 3112 includes first and second switches (e.g., transistors) having first and second switches that are selectively turned on and off periodically in response to control signals 3015 and 3025 provided by controller 3120, wherein each switch has a time T_{ON} in each period where the switch is turned whereby the power level supplied to the installed lamp 10 varies with T_{ON}.

Feedback signal generator 3130 provides a feedback signal 3035 to controller 3120 to create a power control loop that permits controller 3130 to control operation of lamp power supply device 3110 to supply a desired power level to installed lamp 10. In one embodiment, the feedback signal indicates an average current level flowing through half bridge 3112. When V_{IN} is a constant DC voltage, then by regulating the average current through half bridge 3112 controller 3130 can regulate the power supplied to installed lamp 10.

Accordingly, in some embodiments controller 3130 periodically (e.g., once every 850 μsec measurement cycle) measures the average current through half bridge 3112 and in response thereto adjusts the “ON” time T_{ON} to regulate the power supplied to installed lamp 10. That is, in some embodiments, during each measurement cycle controller 3130 will not change T_{ON}, but at the end of the cycle controller 3130 will change T_{ON} for the next cycle based on the half bridge current measurement from the previous cycle to correct and maintain regulation of the power supplied to installed lamp 10.

Lighting unit 3000 is capable of employing at least two different types of lamps as the installed lamp 10, and apparatus 3100 is configured automatically to recognize, detect, or determine the type of lamp that is currently installed in lighting unit as installed lamp 10.

In some embodiments, lighting unit 3000 is configured to employ as installed lamp 10 a fluorescent lamp, in particular a T8 fluorescent lamp. In that case, installed lamp 10 may be a 32 watt T8 lamp (a first lamp type), or a 28 watt T8 lamp (a second lamp type), or a 25 watt T8 lamp (a third lamp type).

In that case, apparatus 3100 includes a feature wherein it is able automatically to detect whether installed lamp 10 is a 32 watt T8 lamp, a 28 watt T8 lamp, or a 25 watt T8 lamp.

In one example embodiment, controller 3130 has information indicating the current value of T_{ON} at all times. By definition, T_{ON-MAX} is the maximum permissible value of T_{ON} for the power control setting for a given installed lamp 10, and this value should not be reached during normal operations of lighting unit 3000 with installed lamp 10. When lamp power supply device 3110 is not able to satisfy its target power requirements, then controller 3130 will set T_{ON} to T_{ON-MAX}.

Beneficially, this is exactly the situation that occurs when a lower power lamp (e.g., a 28 watt T8 lamp) is installed and driven at a higher power regulation set point (e.g., at a first power control setting for a 32 watt T8 lamp). In such a case, having T_{ON} at T_{ON-MAX} is defined as an overdriving condition.

Accordingly, apparatus 3100 may execute a method of detecting a lamp type of installed lamp 10, such as the method 2000. In that case, in step 2010 controller 3120 retrieves data indicating a starting lamp type from the memory device, and in step 2015 apparatus 3100 warms up installed lamp 10 using settings for the starting lamp type. Then in step 2020 apparatus 3100 attempts during a test interval to overdrive installed lamp 10 by employing a power control setting that will not overdrive installed lamp 10 and therefore will not cause T_{ON} to reach at T_{ON-MAX} when installed lamp 10 belongs to a first lamp type (e.g., a 32 W lamp type) intended to operated at a higher power level, but that will overdrive installed lamp 10 and will cause T_{ON} to reach T_{ON-MAX} when installed lamp 10 belongs to a second lamp type (e.g., a 28 W lamp type) intended to operated at a lower power level. In step 2025 controller 3120 detects whether or not installed lamp 10 is overdriven by determining whether, during the test interval, T_{ON} reaches T_{ON-MAX}. In some embodiments, overdriving may be defined as having T_{ON}=T_{ON-MAX} for a percentage of the test interval, and T_{ON} does not have to equal T_{ON-MAX} for 100% of the test interval. Consequently not detecting overdriving may be defined as not having T_{ON}=T_{ON-MAX} for a certain percentage of time during the test interval.

Based at least in part on whether it is determined that installed lamp 10 is overdriven at the first power control setting, controller 3120 determines the lamp type of installed lamp 10. In particular, when only two lamp types (e.g., 32 W and 28 W) are contemplated, then a final decision as to which lamp type is installed may be made once it is determined whether installed lamp 10 is overdriven at the first power control setting. In another case where three lamp types (e.g., 32 W, 28 W, and 25 W) are contemplated, then if installed lamp 10 is overdriven at the first power control setting, it is necessary to repeat the procedure at a second power control setting that will not overdrive installed lamp 10 and therefore will not cause T_{ON} to reach at T_{ON-MAX} when installed lamp 10 belongs to the second lamp type (e.g., a 28 W lamp type), but that will overdrive installed lamp 10 and will cause T_{ON} to reach T_{ON-MAX} when installed lamp 10 belongs to the third lamp type (e.g., a 25 W lamp type) intended to operated at an even lower power level, such as described above with respect to steps 2040-2065 of FIG. 2. As before, depending on the number of lamp types that are contemplated, this procedure may be repeated as necessary. As mentioned earlier, a different embodiment of the procedure may be employed, for example, by beginning testing at the lowest power level and if overdrive is detected, then testing at the next power level above that, and then the next power level above that, etc. until if finds a level that does overdrive the lamp(s).

In some embodiments, once the installed lamp type is determined, controller 3120 may write data indicating the installed lamp type into memory device 3124 as the new starting lamp type.

In some embodiments, the feedback signal reflecting the current through half bridge 3112 may be supplied to a comparator or amplifier 3126 and compared to a reference value corresponding to a desired power level to be applied to installed lamp 10 (for example, a dimmed level corresponding to V_{DIM}) in order to generate the appropriate T_{ON} for the control signal(s) for controlling the power supplied by lamp power supply device 3110 to installed lamp 10. In that case, controller 3120 may determine whether or not T_{ON}=T_{ON-MAX} and installed lamp 10 is overdriven by monitoring whether or not the output of comparator or amplifier 3126 goes “open loop” and is at its maximum (or minimum) “rail” value due to overdriving a lower power lamp. In some embodiments, processor 3122 may just measure T_{ON} directly. Based on whether T_{ON}=T_{ON-MAX}, indicating overdriving, controller 3120 can change the reference value provided to the amplifier or comparator 3126 to properly drive installed lamp 10.

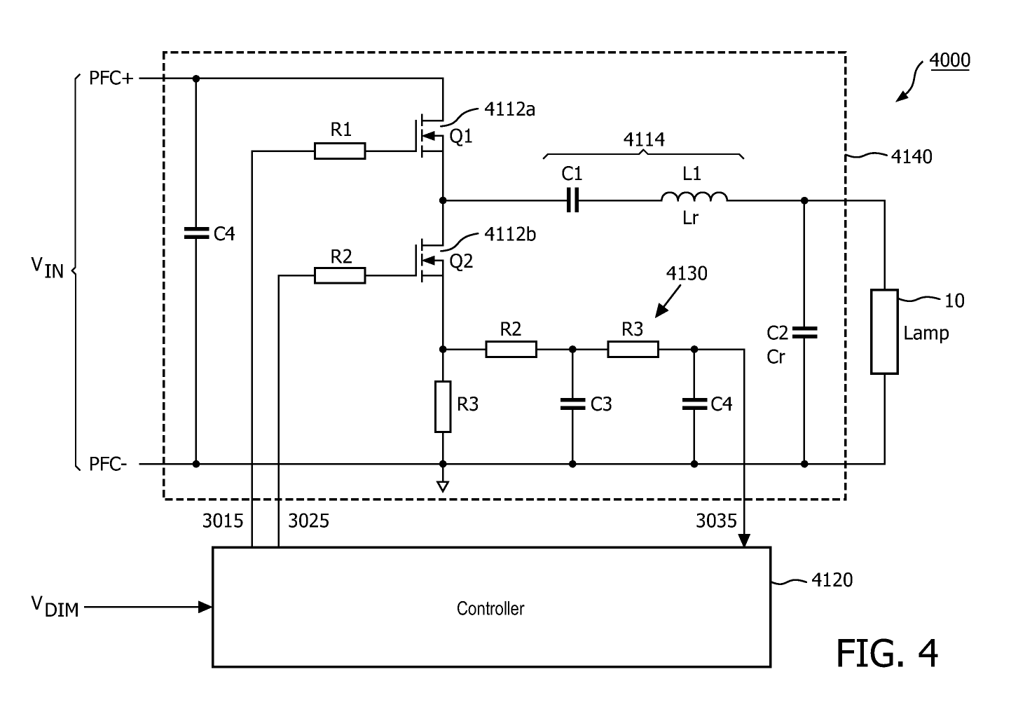

FIG. 4 shows some details of relevant portions of one embodiment of a lighting unit 4000. Lighting unit 4000 includes an installed lamp 10, which may be installed in a lighting fixture (not shown) of lighting unit 4000, and an apparatus 4100 for supplying power to installed lamp 10. Apparatus 4100 includes a lamp power supply device and feedback signal generator 4140, and a controller 4120. Lamp power supply device and feedback signal generator 4140 includes a half-bridge including first and second switching devices (e.g., field effect transistors) 4112a and 4112b, a resonant circuit 4114, and a feedback signal generator 4130.

An operation of lighting unit 4000 is the same as lighting unit 3000 and therefore will not be repeated here.

In one embodiment, a lighting unit may operate according to the parameters shown in Table 1 below.

TABLE 1

| parameter | value | description |
|---|---|---|
| POST_IGNITION_LAMP_REC_DELAY_TIME | 1 [sec] | Earliest time after |
| | | ignition when lamp |
| | | recognition procedure |
| | | may start |
| LAMP_RECOGNITION_WARM_UP_TIME | 60 [sec] | Warm-up time before |
| | | the overdriving test |
| LAMP_RECOGNITION_DO_TIME | 100 [msec] | Overdriving test |
| | | duration |
| LAMP_RECOGNITION_SWEEP_TIME | 500 [msec] | Time to move to |
| | | overdriving wattage or |
| | | return from it if needed |
| LAMP_RECOGNITION_LEVEL | 94 [%] | Minimum output light |
| | | level suitable for warm- |
| | | up (100% is full-on) |
| LAMP_RECOGNITION_OVERDRIVE_RATIO | 50 [%] | Percentage of time |
| | | during the overdriving |
| | | test sufficient for |
| | | positive result. |

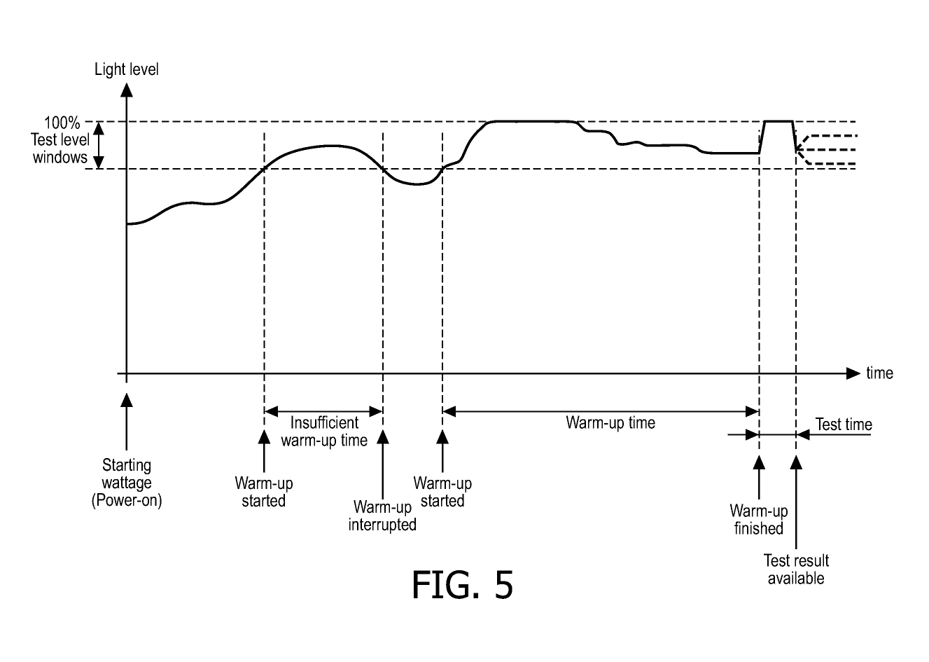

FIG. 5 illustrates the timing of one embodiment of a procedure for a lighting unit to determine a lamp type of an installed lamp, showing a light level as a function of time during a start-up or power-on procedure, including a warm-up period and a test interval.

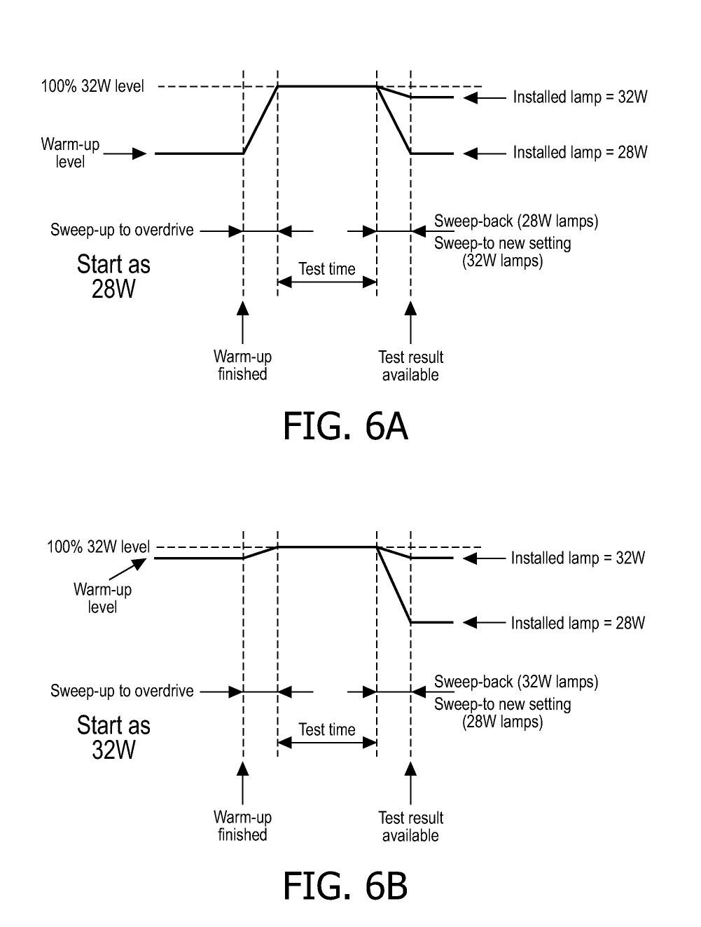

FIGS. 6A-B illustrate example operations of one embodiment of a lamp type determination procedure where it is contemplated that a lighting unit may operate with two different lamp types: a 32 W lamp and a 28 W lamp. FIGS. 6A-B illustrate four different possible cases for lamp recognition, according to the starting lamp type stored in memory and employed for start-up and the lamp type of the actual installed lamp, as illustrated in Table 2 below.

TABLE 2

| Starting lamp type | Installed lamp(s) |
|---|---|
| [W] | [W] |
| 28 | 28 |
| 28 | 32 |
| 32 | 28 |
| 32 | 32 |

FIG. 6A illustrates the two cases where the starting lamp type is 28 W and therefore the lighting unit starts up as if the lamp type of the installed lamp(s) is 28 W. In the first case (top trace at right), the installed lamp is a 32 W lamp, and in the second case (bottom trace at right), the installed lamp is a 28 W lamp. FIG. 6BA illustrates the two cases where the starting lamp type is 32 W and therefore the lighting unit starts up as if the lamp type of the installed lamp(s) is 32 W. In the first case (bottom trace at right), the installed lamp is a 28 W lamp, and in the second case (top trace at right), the installed lamp is a 32 W lamp.

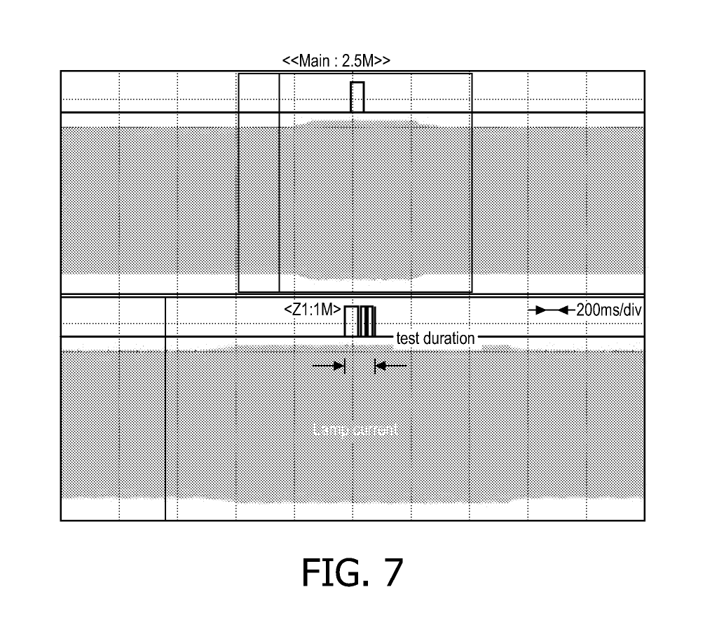

FIGS. 7-10 illustrate experimental results of execution of one embodiment of a lamp type determination algorithm under four different sets of conditions. Each of the FIGS. 7-10 shows a top trace and a bottom trace, wherein the top and bottom traces show the same signals at different time scales, the bottom trace having a time trace that is an exploded view around the time enclosed within the rectangular box drawn on the top trace.

FIG. 7 illustrates a case where the lighting unit has a starting lamp type for a 28 W lamp, and the actual installed lamp is a 28 W lamp. Here, the top trace has a time scale of 500 msec. /division, and the bottom time trace has a time scale of 200 msec. /division. As shown in FIG. 7, after a warm up period of about 1 minute wherein the installed lamp is warmed up in accordance with a warm up setting for a 28 W lamp, the lighting unit attempts to overdrive the installed lamp during a test interval for determining a lamp type for the installed lamp. In particular, power is supplied to the installed lamp according to a first power control setting that will not overdrive the installed lamp when the installed lamp is a 32 W lamp, but that will overdrive the installed lamp when the installed lamp is a 28 W lamp. In this case, an overdrive condition is detected, and so the lamp is determined to be a 28 W lamp, and is thereafter driven using a power control setting (e.g., T_{ON}) for a 28 W lamp.

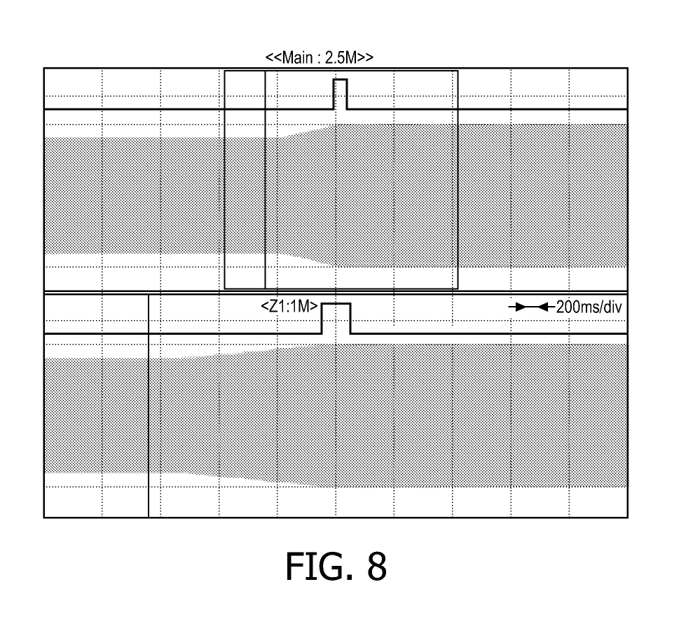

FIG. 8 illustrates a case where the lighting unit has a starting lamp type for a 28 W lamp, and the actual installed lamp is a 32 W lamp. Here, the top trace has a time scale of 500 msec. /division, and the bottom time trace has a time scale of 200 msec. /division. As shown in FIG. 8, after a warm up period of about 1 minute wherein the installed lamp is warmed up in accordance with a warm up setting for a 28 W lamp, the lighting unit attempts to overdrive the installed lamp during a test interval for determining a lamp type for the installed lamp. In particular, power is supplied to the installed lamp according to a first power control setting that will not overdrive the installed lamp when the installed lamp is a 32 W lamp, but that will overdrive the installed lamp when the installed lamp is a 28 W lamp. In this case, an overdrive condition is not detected, and so the lamp is determined to be a 32 W lamp, and is thereafter driven using a power control setting (e.g., T_{ON}) for a 32 W lamp. Furthermore, the starting lamp type may be updated to reflect a 32 W lamp.

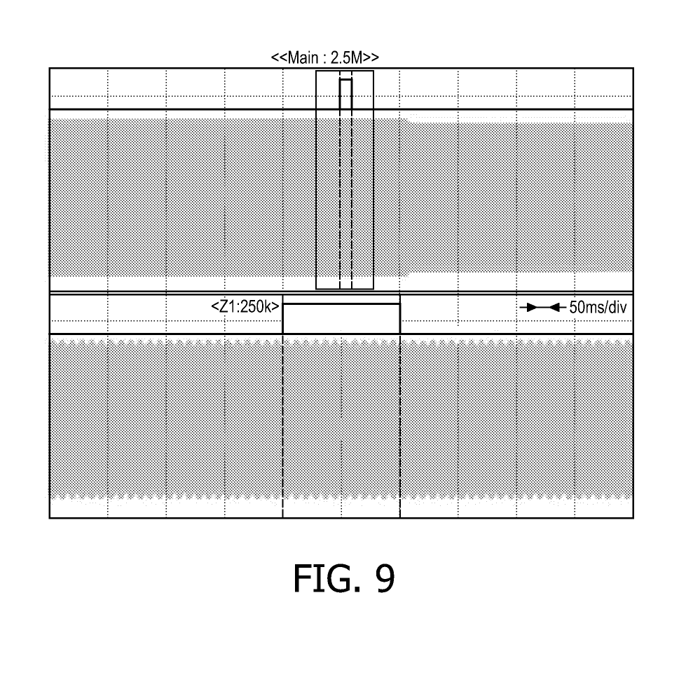

FIG. 9 illustrates a case where the lighting unit has a starting lamp type for a 32 W lamp, and the actual installed lamp is a 28 W lamp. Here, the top trace has a time scale of 500 msec. /division, and the bottom time trace has a time scale of 50 msec. /division. As shown in FIG. 9, after a warm up period of about 1 minute wherein the installed lamp is warmed up in accordance with a warm up setting for a 32 W lamp, the lighting unit attempts to overdrive the installed lamp during a test interval for determining a lamp type for the installed lamp. In particular, power is supplied to the installed lamp according to a first power control setting that will not overdrive the installed lamp when the installed lamp is a 32 W lamp, but that will overdrive the installed lamp when the installed lamp is a 28 W lamp. In this case, an overdrive condition is detected, and so the lamp is determined to be a 28 W lamp, and is thereafter driven using a power control setting (e.g., T_{ON}) for a 28 W lamp. Furthermore, the starting lamp type may be updated to reflect a 28 W lamp.

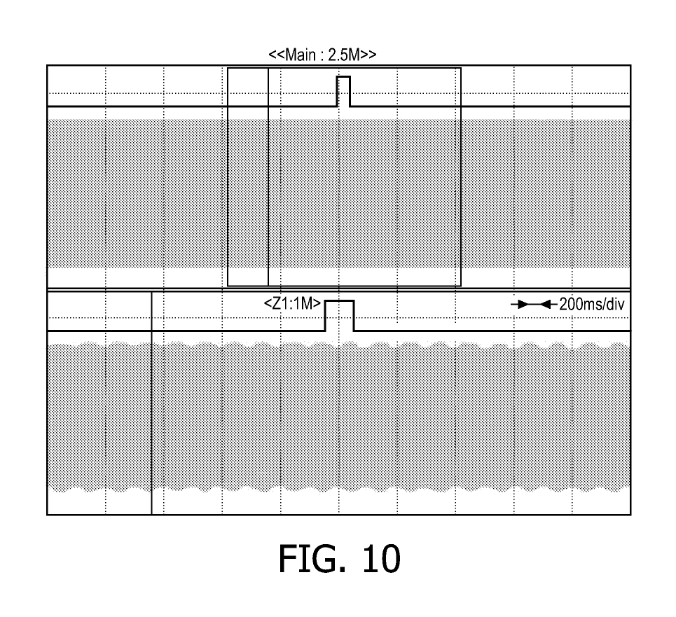

FIG. 10 illustrates a case where the lighting unit has a starting lamp type for a 32 W lamp, and the actual installed lamp is a 32 W lamp. Here, the top trace has a time scale of 500 msec. /division, and the bottom time trace has a time scale of 200 msec. /division. As shown in FIG. 10, after a warm up period of about 1 minute wherein the installed lamp is warmed up in accordance with a warm up setting for a 32 W lamp, then the lighting unit attempts to overdrive the installed lamp during a test interval for determining a lamp type for the installed lamp. In particular, power is supplied to the installed lamp according to a first power control setting that will not overdrive the installed lamp when the installed lamp is a 32 W lamp, but that will overdrive the installed lamp when the installed lamp is a 28 W lamp. In this case, an overdrive condition is not detected, and so the lamp is determined to be a 32 W lamp, and is thereafter driven using a power control setting (e.g., T_{ON}) for a 32 W lamp.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of and “consisting essentially of shall be closed or semi-closed transitional phrases, respectively, as set forth in the United States Patent Office Manual of Patent Examining Procedures, Section 2111.03.

1. A device for supplying power to an installed fluorescent lamp, the device comprising:
a first circuit for receiving an input voltage (V_{IN}) and in response thereto supplying power to the installed fluorescent lamp, the first circuit including:
a half bridge having first and second switches that are selectively turned on and off periodically, wherein each switch has a time T_{ON} in each period where the switch is turned on, and wherein the power level supplied to the installed fluorescent lamp varies with T_{ON}, and
a resonant circuit for supplying the power from the half bridge to the installed fluorescent lamp;
a feedback signal generator for supplying a feedback signal indicating an average current passing through the half bridge;
a controller for receiving the feedback signal and in response thereto adjusting T_{ON}; and
a memory device for storing a starting lamp type,
wherein the controller executes a lamp type determination procedure for the installed fluorescent lamp, comprising:
retrieving from the memory device data indicating the starting lamp type;
supplying first and second control signals according to the starting lamp type to the first and second switches to cause the first circuit to warm-up the installed fluorescent lamp during a warm-up period;
after the warm-up period, during a test interval supplying the first and second control signals to the first and second switches to cause the first circuit to supply power to the installed fluorescent lamp to attempt to overdrive the installed fluorescent lamp;
monitoring T_{ON} during the test interval;
determining the lamp type of the installed fluorescent lamp based on the monitored T_{ON}; and
saving in the memory device data indicating the determined lamp type of the installed fluorescent lamp as the starting lamp type.

2. The device of claim 1, wherein the installed fluorescent lamp has one of a first lamp type corresponding to a first, higher, power level, and a second lamp type corresponding to a second, lower, power level, and wherein the controller sets a maximum value T_{ON-MAX} for T_{ON} during the test interval corresponding to the first lamp type, and compares the monitored T_{ON} to T_{ON-MAX}.

3. The device of claim 2, wherein the controller determines whether the installed fluorescent lamp belongs to the first lamp type or belongs to the second lamp type depending on whether the monitored T_{ON} equals T_{ON-MAX} during the test interval.

4. The device of claim 2, wherein the controller sets a threshold percentage, and determines whether the installed fluorescent lamp belongs to the first lamp type or belongs to the second lamp type depending on whether the monitored T_{ON} equals T_{ON-MAX} for at least the threshold percentage of time during the test interval.

5. The device of claim 2, wherein the feedback signal has a value, and wherein the controller compares the feedback signal value to a target value and in response thereto adjusts T_{ON} to attempt to cause the feedback signal value to equal the target value.

6. The device of claim 5, wherein the target value is selected according to one of the first and second lamp types.

7. The device of claim 6, wherein the controller includes a comparator or amplifier that compares the feedback signal value to the target value, and wherein the controller determines that T_{ON} equals T_{ON-MAX} when an output of the comparator or amplifier is at one of its maximum and minimum values.

8. The device of claim 6, wherein the controller includes a processor that measures T_{ON}.

9. (canceled)

10. (canceled)

11. (canceled)

12. (canceled)

13. (canceled)

14. (canceled)

15. A method, comprising:
supplying power to an installed lamp according to a first power control setting that will not overdrive the installed lamp when the installed lamp is of a first lamp type, and that will overdrive the installed lamp when the installed lamp is of a second lamp type and includes selectively turning on and off first and second switches of a half bridge periodically, wherein each switch has a time T_{ON} in each period where the switch is turned on, and wherein a power level supplied to the installed lamp varies with T_{ON};
detecting whether the installed lamp is overdriven at the first power control setting;
determining the lamp type of the installed lamp based at least in part on whether the installed lamp is overdriven at the first power control setting; and
supplying the power to the installed lamp according to the determined lamp type,
wherein the first lamp type corresponds to a first, lower, power level, and the second lamp type corresponds to a second, higher, power level, and the method comprises, during a test interval;
setting a maximum value T_{ON-MAX} for T_{ON} corresponding to the first lamp type,
monitoring T_{ON}, and
comparing the monitored T_{ON} to T_{ON-MAX};

16. The method of claim 15, further comprising comparing a feedback signal to a target value for driving the installed lamp, and determining whether the installed lamp is overdriven based on a result of the comparison.

17. (canceled)

18. (canceled)

19. The method of claim 15, further comprising determining whether the installed lamp belongs to the first lamp type or belongs to the second lamp type depending on whether the monitored T_{ON} equals T_{ON-MAX} during the test interval.

20. The method of claim 15, further comprising:
supplying the power to the installed lamp according to a second power control setting that will not overdrive the installed lamp when the installed lamp is of the second lamp type, and that will overdrive the installed lamp when the installed lamp is of a third lamp type;
detecting whether the installed lamp is overdriven at the second power control setting; and
determining the lamp type of the installed lamp based at least in part on whether the installed lamp is overdriven at the second power control setting.

21. The method of claim 15, wherein the first lamp type corresponds to a first, higher, power level lamp, and the second lamp type corresponds to a second, lower, power level lamp.

22. The method of claim 15, further comprising saving in a memory device data indicating the determined lamp type of the installed lamp.
